(19) United States
(12) Patent Application Publication
(10) Pub. No.: US 2015/0326874 A1
(43) Pub. Date: Nov. 12, 2015

(54) APPARATUS AND METHOD FOR CODING A VIDEO SIGNAL

(71) Applicant: Lukasz LITWIC, Chandlers Ford (GB)

(72) Inventor: Lukasz LITWIC, Chandlers Ford (GB)

(73) Assignee: TELEFONAKTIEBOLAGET L M ERICSSON (PUBL), Stockholm (SE)

(21) Appl. No.: 14/409,427

(22) PCT Filed: Jun. 21, 2012
(86) PCT No.: PCT/EP2012/061976

§ 371 Date: Dec. 18, 2014

(51) Int. Cl. H04N 19/507; H04N 19/85; H04N 19/172

(52) U.S. Cl. CPC H04N 19/507; H04N 19/172; H04N 19/85

(57) ABSTRACT

An apparatus and method are provided for coding a video signal, wherein each picture frame of the video signal comprises one or more corresponding reference frames, each reference frame R comprising a first field (for example a top field or a bottom field) and a second field (for example a bottom field or top field). A current frame to be coded is received, and a first field or a second field of a reference frame selected for coding a first field of the current frame. The selecting is performed based on the video content of the reference frame. The first field of the current frame is coded using the selected field of the reference frame.

### TECHNICAL FIELD

The present invention relates to an apparatus and method for coding a video signal, for example a video signal in which each picture frame of the video signal is associated with one or more reference frames, each reference frame comprising a first field and a second field (for example a top field and a bottom field, or vice versa).

### BACKGROUND

In dense video encoding or transcoding applications, a video compression algorithm may be required to use only a portion of resources than would be normally used in a single channel “best effort” configuration of the algorithm. This is to allow a few instances of a video compression algorithm to run in parallel.

Since video compression algorithms are based on coding the residual error of a motion-compensated prediction, a significant amount of the algorithm resource is dedicated to Motion Estimation. Error signals are generated by calculating the differences between input source pictures and reconstructed (already encoded) pictures which are stored in reference picture buffers. The objective of the algorithm is to minimize the errors at all times so that small amounts of data are required to be transmitted.

There are three types of pictures (or frames) used in video compression, known as I-frames, P-frames, and B-frames. An I-frame is an ‘Intra-coded picture’, in effect a fully specified picture, like a conventional static image file. P-frames and B-frames hold only part of the image information, so they need less space to store than an I-frame, and thus improve video compression rates.

A P-frame (‘Predicted picture’) holds only the changes in the image from the previous frame. For example, in a scene where an object moves across a stationary background, only the movement of the object needs to be encoded. The encoder does not need to store the unchanging background pixels in the P-frame, thus saving space. P-frames are also known as delta-frames.

A B-frame (‘Bi-predictive picture’) saves even more space by using differences between the current frame and both the preceding and following frames to specify its content.

Thus, in order to remove maximum redundancy from a source picture prior to encoding, a typical video compression algorithm uses one or more stored reference pictures to code one input picture. This makes Motion Estimation one of the most expensive operations in a coding algorithm. Therefore, reducing the number of reference pictures used by Motion Estimation helps reduce the computational complexity of the overall coding algorithm.

In the H.264 video coding standard, as applied to interlaced coding, reference pictures are stored as complete frames. Therefore, the number of reference pictures, fields in this case, is twice that of progressive picture coding but without any performance penalty for a decoder. Therefore, in the interlaced case, where the number of reference fields is restricted, the encoder may be allowed to use only one field from the stored reference frame.

The H.264 video coding standard specifies the default initialization procedure for reference picture lists to start with a field having the same parity field as the encoded field. In the described case of interlaced coding an encoder can use only one field from a reference frame. This means that for coding a top field a top reference field is used. On the other hand if the currently coded field is a bottom field, a bottom field from a reference frame is used. This can have the following implications for the video quality.

FIG. 1a shows an example whereby a top field X₁ of a frame X references a top field Q₁ of a frame Q in the past (top fields of each frame being shown with hatched lines, and the bottom fields shown without any hatched lines). However, in the case of a strong motion between the top and bottom fields in the video signal, a bottom field Q₂ of frame Q is much more correlated with the top field X₁ of frame X. As such, according to the convention in H.264 the best reference field is not used.

FIG. 1b shows an example whereby a bottom field X₂ of a reference frame X references a bottom field Q₂ of a frame Q in the past, even though a top field Q₁ of frame Q is much closer temporally. As such, according to the convention in H.264 the best reference field is not used.

FIG. 1c shows an example whereby a bottom field Y₂ of a non-reference frame Y references a bottom field Q₂ of a frame Q in the past, even in the case that the top field Q₁ of a frame Q is of better quality and there is no temporal difference between the top field Q₁ and the bottom field Q₁ of the frame Q. As such, according to the convention in H.264 the best reference field is not used.

FIG. 1d shows an example whereby a bottom field X₂ of a frame X references a bottom field Z₂ of frame Z in the future even though a top field Z₁ of the frame Z is of better quality and closer temporally. As such, according to the convention in H.264 the best reference field is not used.

FIG. 2 shows how reference pictures are used in prior art coders that are configured to operate as described above. FIG. 2 shows a series of frames, 21, 22, 23, 24 and 25. Each frame is shown as comprising a top field 21₁, 22₁, 23₁, 24₁, 25₁, and a corresponding bottom field 21₂, 22₂, 23₂, 24₂, 25₂. Frames 21 and 25 correspond to P-picture frames, with the dashed line corresponding to their associated reference picture vectors. Frames 22 and 24 correspond to B-picture frames, with the solid line corresponding to their associated reference picture vectors. Frame 23 corresponds to a Reference B-picture frame, with the dotted line corresponding to its reference picture vectors.

As can be seen from FIG. 2, a top field 23₁ of the Reference B-picture frame 23 is only able to reference the top field 25₁ of P-picture frame 25 (corresponding to a frame in the future) and top field 21₁ of P-picture frame 21 (corresponding to a frame in the past). Likewise, a bottom field 23₂ of Reference B-picture frame 23 is only able to reference the bottom field 25₂ of P-picture frame 25 (corresponding to a frame in the future) and bottom field 21₂ of P-picture frame 21 (corresponding to a frame in the past). The same applies to the other frames, whereby it can be seen that a top field is only able to reference a top field of another frame, and a bottom field only able to reference a bottom field of another frame.

As mentioned above, this has the disadvantage that the best suited reference field is not necessarily used for coding.

### SUMMARY

It is an aim of the present invention to provide a method and apparatus which obviate or reduce at least one or more of the disadvantages mentioned above.

According to a first aspect of the present invention there is provided a method for coding a video signal, wherein each picture frame of the video signal is associated with one or more reference frames, each reference frame comprising a first field and a second field. The method comprises the steps of receiving a current frame to be coded, and selecting a first field or a second field of a reference frame for coding a first field of the current frame. The selection is performed based on the content of the video signal. The first field of the current frame is coded using the selected field of the reference frame.

An advantage of such an embodiment is that it provides a choice or dynamic selection between the first and second reference fields provided in each frame (for example between the top and bottom fields, or vice versa, depending upon which field is currently being coded), whereby the choice is optimized based on the content of the video signal, for example a temporal proximity between top and bottom fields of the same frame

According to another aspect of the invention there is provided a video encoding apparatus for coding a video signal, wherein each picture frame of the video signal is associated with one or more reference frames, each reference frame comprising a first field and a second field. The apparatus comprises a receiving unit for receiving a current frame to be coded. A processing unit is adapted to select a first field or a second field of a reference frame for coding a first field of the current frame. The selection is performed based on the content of the video signal. A coding unit is adapted to code the first field of the current frame using the selected field of the reference frame.

### BRIEF DESCRIPTION OF THE DRAWINGS

For a better understanding of the present invention, and to show more clearly how it may be carried into effect, reference will now be made, by way of example only, to the following drawings in which:

FIGS. 1a to 1d show how top and bottom fields are coded using reference frames according to the prior art;

FIG. 2 shows how reference pictures are used in prior art coders;

FIG. 3 shows a method performed by an embodiment of the present invention;

FIG. 4 shows a method performed by another embodiment of the present invention;

FIG. 5 shows a video encoding apparatus according to an embodiment of the present invention;

FIG. 6 shows a method performed by another embodiment of the present invention;

FIG. 7 shows how reference pictures can be used according to embodiments of the present invention; and

FIG. 8 shows a method performed by another embodiment of the present invention.

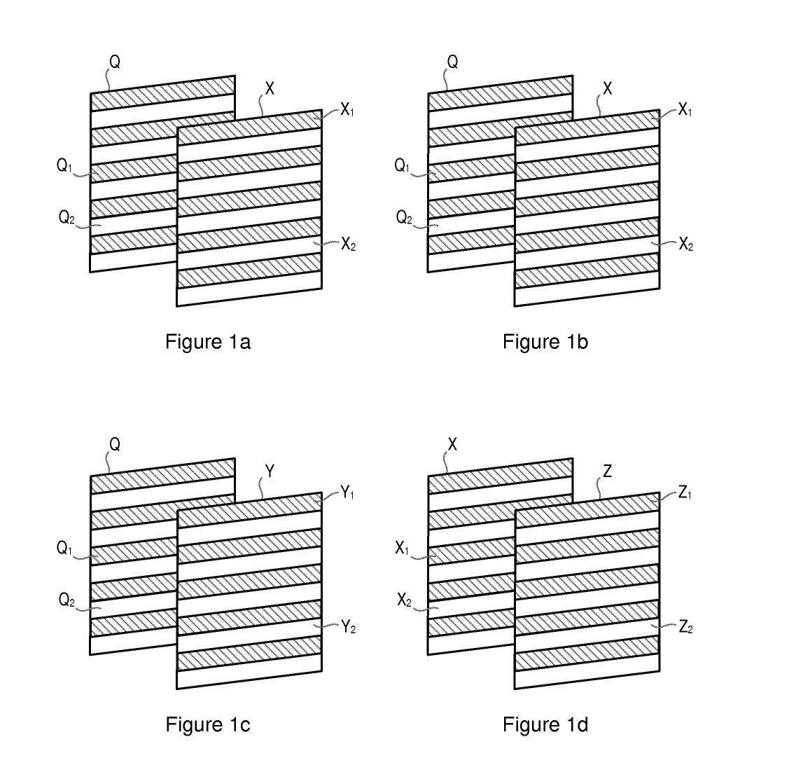

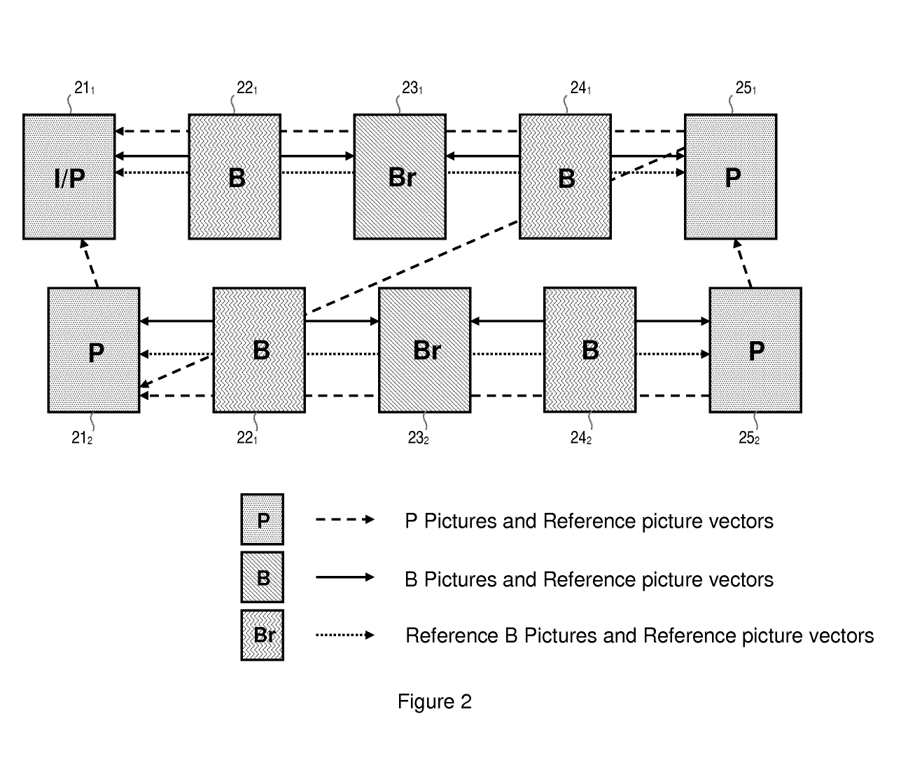

### DETAILED DESCRIPTION

The embodiments of the invention described below provide a method and apparatus for enabling a selection to be made when using a field from a reference frame to code a current field of a picture frame. The embodiments of the invention select reference frames with regard to the content of the video signal itself, for example based on the temporal proximity between top and bottom fields of the same frame (which provides an indication of motion in the frame), so that redundancy between current coded fields and reference fields can be maximized, and removed from the current coded field prior to its encoding.

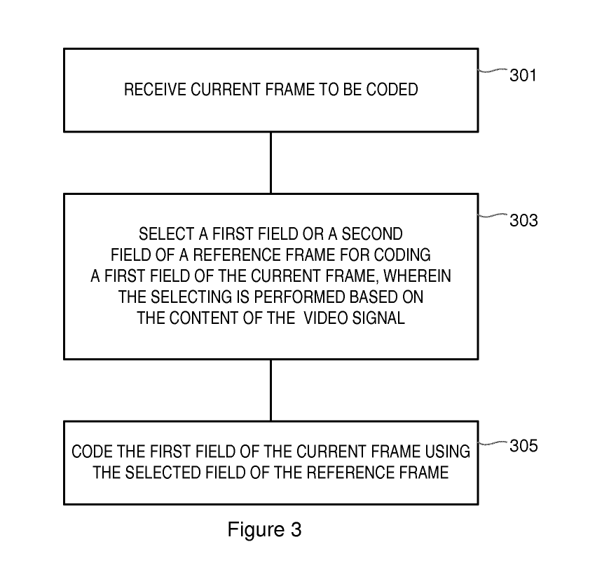

FIG. 3 shows a method performed by an embodiment of the present invention for coding a video signal, wherein each picture frame of the video signal is associated with one or more reference frames, each reference frame R comprising a first field and a second field (for example a top field and a bottom field, or vice versa). In step 301 a current frame to be coded is received. The method comprises selecting a first field or a second field of a reference frame R for coding a first field X of the current frame. The selecting is performed based on the content of the video signal, step 303. In step 305 the first field X of the current frame is coded using the selected field of the reference frame.

It is noted that, depending on the type of coding being used, the reference frame X may be from a previous frame, a future frame, or the same frame as a current frame.

By providing a selection between the first (e.g. top) or second (e.g. bottom) fields of a reference frame, this means that the best suited frame can be used for coding, rather than just using a like-for-like default as provided by the prior art. This enables the best suited frame to be selected based on the content of the video signal, and enables maximum redundancy to be removed from a source picture prior to encoding. The selection can be performed dynamically as the field of the relevant reference frame is being used to code a current field of a frame.

According to one embodiment the selecting step comprises the steps of determining whether the reference frame R is marked as a “still type” frame or a “moving type” frame, and selecting a first field or a second field of a reference frame R according to whether the reference frame R is marked as a still type frame or a moving type frame. As will be explained in greater detail below, a “still type” frame is a frame where there is no or little motion between top and bottom fields, for example if motion between top and bottom fields is below a predetermined threshold. A “moving type” frame is a frame where the motion between top and bottom fields is above a threshold.

Where the first field is a top field, an embodiment of the invention comprises the step of selecting the first field (top field) of the reference frame R when the reference frame R is marked as a still type frame. In a similar way, if the first field is a bottom field, this embodiment comprises the step of selecting the second field (bottom field) of the reference frame R when the reference frame R is marked as a still type frame.

Where the first field is a top field, and the reference frame marked as a moving type frame, this embodiment of the invention comprises the step of selecting the second field (bottom field) of the reference frame R. In a similar way, if the first field is a bottom field, and the reference frame marked as a moving type frame, this embodiment comprises the step of selecting the first field (top field) of the reference frame R.

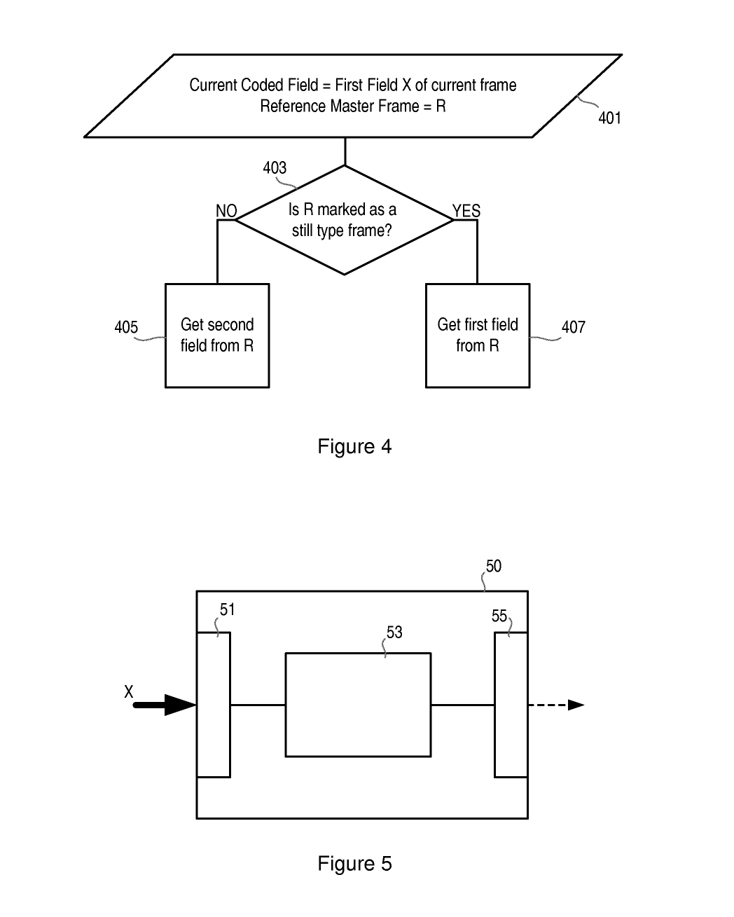

FIG. 4 shows the steps performed by such a method, whereby a current coded field equals a first field X of a current frame, and whereby a reference field is from a reference frame R, 401. In step 403 it is determined whether the reference frame is marked as a still type frame. If not, then the second field of the reference frame R is fetched for coding with the first field of the current frame X, step 405. If the reference frame R is determined to be marked as a still type frame in step 403, then the first field of the reference frame R is fetched for coding with the first field of the current frame X, step 407.

In the embodiment above it can be seen that the selection between fields is based on whether the reference frame R is marked as “still type” or “moving type”, which provides a simple way of indicating the content of the video signal, and hence which field of the reference frame should be selected.

Selecting a top-to-top field or bottom-to-bottom field (i.e. like-for-like between the current coded field and the reference field) has an advantage when there is no or little motion in the content of the video signal, for example below a certain threshold level of motion. As will be described in further detail below, such frames are marked as “still” type frames during a pre-processing stage.

Selecting the second field (for example top-field referencing bottom-field, or bottom-field referencing top-field) has an advantage when there is more that a certain amount of motion in the content of the video signal, for example more than a threshold level of motion, i.e. as determined between the first and second fields of the same frame, in which case the frames are marked as “moving type” frames during a pre-processing stage, again as described in further detail below.

In order to enable the selection process to be carried out as described in the embodiments above, the following pre-processing stage may be carried out on frames of the video signal to be encoded. The pre-processing stage comprises the steps of measuring a temporal proximity between two adjacent frames, for example a current frame and a previous frame. The temporal proximity may be measured between the top fields (e.g. first fields) of the two adjacent frames and the bottom fields (e.g. second fields) of the two adjacent frames of the video signal, such that each frame can be marked as a still type or moving type frame. This enables the motion between two fields of the same frame to be inferred from motion detected between the adjacent frames. Each frame of the video signal may be processed in this way during a pre-processing stage, such that each frame can be marked as a still type frame or a moving type frame, thereby indicating the degree of temporal proximity between the current and previous frame. It is determined whether the temporal proximity (or motion) between the current and previous frame is smaller than a predetermined threshold. If so, the reference frame R is marked as a still type frame. If not, the reference frame R is marked as a moving type frame. Therefore, the marking of frames as still type or moving type provides signalling information that can be used internally with an encoder to improve the coding process.

The pre-processing stage is therefore carried out to determine the nature of the content of the video signal, i.e. to determine the amount of motion (temporal difference) in the video signal, such that the reference frame can be marked as either “still type” or “moving type” depending on the degree of motion.

It will be appreciated from the above that the choice of field from a reference frame is selected according to the content of the video signal, and can therefore change dynamically as the video signal is being coded.

The embodiments of the invention include a preprocessing stage where a difference between top and bottom fields of the same frame is effectively measured, by comparing one frame with an adjacent frame. The aim of the algorithm is to mark frames where there is no or little motion between the top and bottom fields as still type frames. If motion is detected between the fields the frame is marked as a moving type frame.

According to one embodiment, the pre-processing step may comprise the steps of performing the measuring and determining steps for a group of frames, and marking the group of frames as a still type or a moving type. This has the advantage that, rather than marking each frame separately, frames are grouped together, such that the switching from one mode to another mode happens less frequently. This enables the method to switch from using a first reference field to using a second reference field in response to a group of frames being determined as changing from a still type to a moving type, or vice versa.

This can avoid problems associated with the method switching too frequently on a frame by frame basis, by instead switching from one mode to another mode upon detecting a transition from one type of group to another.

In such an embodiment the marking can be applied to a plurality of frames, the plurality of frames forming a group having it's own template for indicating whether they are marked as still type or moving type.

The method may further comprise the step of signalling reordering messages in a bit-stream, according to the H.264 standard, as will be known to a person skilled in the art.

FIG. 5 shows a video encoding apparatus 50 for coding a video signal according to another embodiment of the invention, wherein each picture frame of the video signal is associated with one or more reference frames R, each reference frame R comprising a first field and a second field. The apparatus comprises a receiving unit 51 for receiving a current frame to be coded. A processing unit 53 is adapted to dynamically select a first field or a second field of a reference frame R for coding a first field X of the current frame. The selection is performed based on the content of the video signal. A coding unit 55 is adapted to code the first field X of the current frame using the selected field of the reference frame R. It is noted that the frames may be stored in a Reference Picture Store, for example, not shown.

As mentioned above, by configuring the video encoding apparatus to select between the first (e.g. top) or second (e.g. bottom) fields of a reference frame, this means that the best suited field can be used for coding, rather than just using a like-for-like default as provided by the prior art. This enables the best field to be selected dynamically based on the content of the video signal, and enables maximum redundancy to be removed from a source picture prior to encoding

The processing unit 53 of FIG. 5 may be further adapted to determine whether the reference frame R is marked as a still type frame or a moving type frame, and select a first field or a second field of a reference frame R according to whether the reference frame R is marked as a still or a moving type frame. For example, the processing unit 53 can be adapted to select the first field of the reference frame R when the reference frame R is marked as a still type frame.

The processing unit 53 can be adapted to select the second field of the reference frame R when the reference frame R is marked a moving type frame.

Where the first field is a top field, the video encoding apparatus is configured to select the first field (top field) of the reference frame R when the reference frame R is marked as a still type frame. In a similar way, if the first field is a bottom field, the video encoding apparatus is configured to select the second field (bottom field) of the reference frame R when the reference frame R is marked as a still type frame.

Where the first field is a top field, and the reference frame marked as a moving type frame, the video encoding apparatus is configured to select the second field (bottom field) of the reference frame R. In a similar way, if the first field is a bottom field, and the reference frame marked as a moving type frame, the video encoding apparatus is configured to select the first field (top field) of the reference frame R.

The processing unit 53 can be further adapted, during a pre-processing stage, to perform the operations of measuring a temporal proximity (or motion) between two adjacent frames, the top fields of the two adjacent frames and the bottom fields of the two adjacent frames of the video signal, and determine whether the temporal proximity between the current and previous frame is smaller than a predetermined threshold. If so, the processing unit 53 is adapted to mark the frame as a still type frame. If not, the processing unit 53 is adapted to mark the frame as a moving type frame.

According to one embodiment the processing unit 53 is adapted to perform the measuring and determining operations for a group of frames, and mark the group of frames as a still type or a moving type. With such an embodiment the processing unit is adapted to switch from using a first reference field to using a second reference field in response to a group of frames being determined as changing from a still type to a moving type, or vice versa.

The processing unit is further adapted to signal reordering messages in a bit-stream, as will be familiar to a person skilled in the art according to the H.264 standard.

It can be seen from the above that the embodiments of the invention are based on two assumptions. The first is that the largest redundancy between a pair of fields exists for fields having the smallest temporal distance between them. If a reference frame is marked as a still type frame or there is no or very little motion between top and bottom fields, a top field may be a better choice as a reference field even though the bottom field yields a smaller temporal distance, or vice versa. This may be due to a better quality of the top field. For example, a top field coded as an I picture may be of better quality than a bottom field coded as a P picture.

It can also be seen from the above that the embodiments of the invention comprise a pre-processing stage of marking frames as still type or moving type. Reference fields are then selected accordingly, and reordering messages signaled in a bit stream.

It is noted that the embodiments of the invention assume that two reference fields are available for P pictures and one reference field per list available for B pictures. This configuration gives an equal number of operations in Motion Estimation and Subpel Refinement. In the case where only one reference field is available for P pictures the embodiments of the invention operate in the same manner as for B pictures.

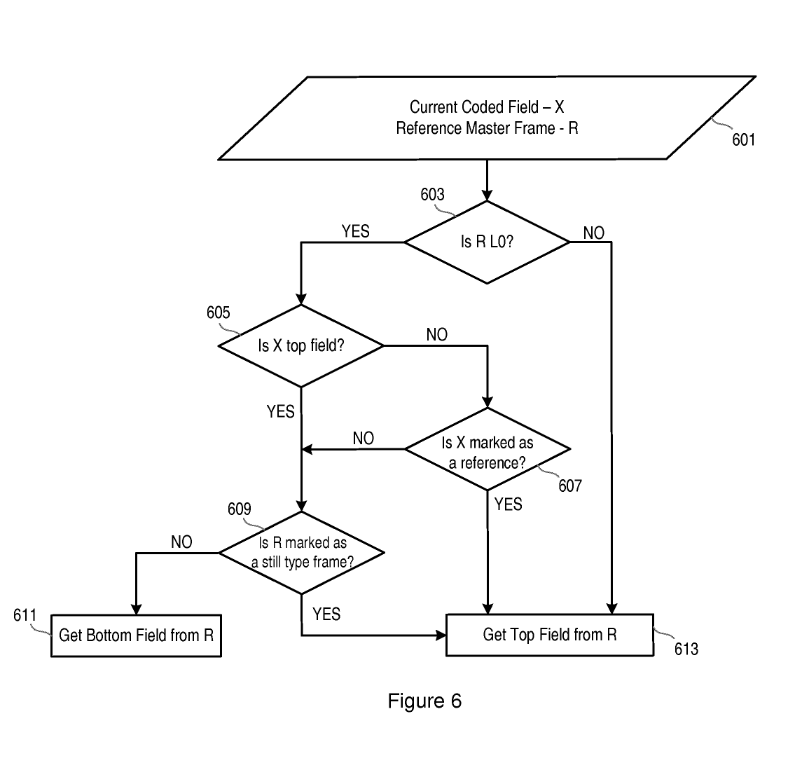

FIG. 6 shows a method performed according to an embodiment of the invention, and in particular the selection procedure for B pictures or for a P picture if only one reference is available.

A current coded field is shown as X, and a reference master frame shown as R, 601. In step 603 it is determined whether the reference frame R relates to a past reference frame or a future reference frame (for example by checking whether the reference frame R is marked as being low (LO), whereby a reference frame marked as LO indicates that the reference frame is a past reference frame).

If it is determined in step 603 that the reference frame R is LO (indicating a past reference frame), then in step 605 it is determined whether or not the current coded field X is a top field. If so, processing moves to step 609 where it is determined whether the reference frame is marked as a still type frame. If so, then the top field of the reference frame is fetched, step 613, for use in coding the current coded field X, which as previously determined is also a top field. If in step 609 it is determined that the reference frame is not marked as a still type frame (and as such is a moving type frame), then the bottom field of the reference frame R is fetched for coding with the current coded field X, step 611, which as previously determined is a top field.

It can be seen from the above that, if the current coded field is a top field, then the selection process is made as described above, regardless of whether or not the current coded field X is marked as a reference field itself, or not. This part of the method is therefore similar to the embodiments described above.

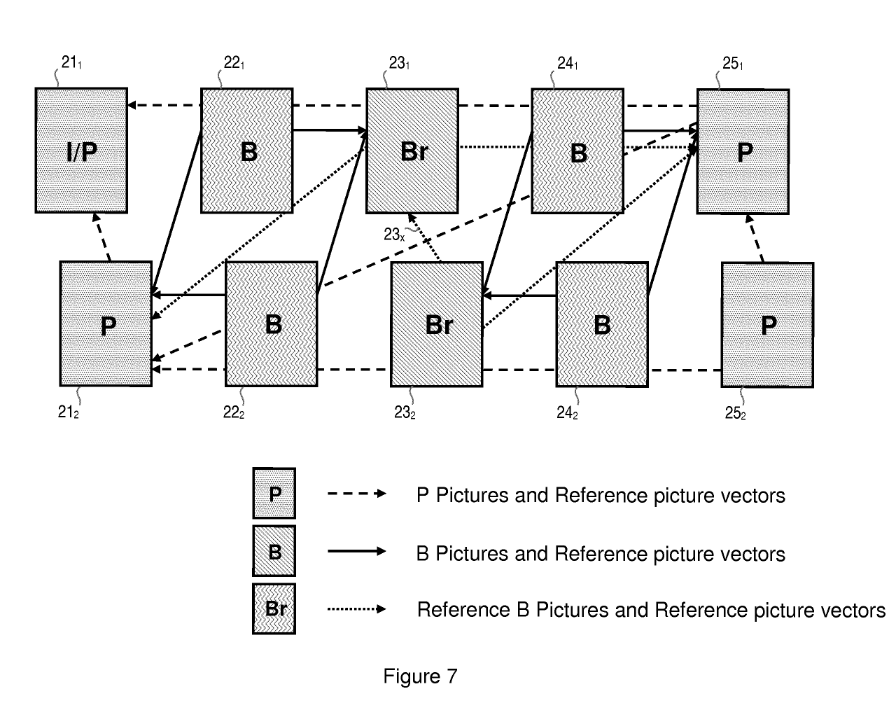

However, the method of FIG. 6 is also able to deal with the different selection that can be made depending upon whether or not the current coded field is itself marked as a reference field or not (for example based on whether the current coded field is a B-picture shown as “B” in FIG. 7 below, or a Reference B-picture shown as “Br” in FIG. 7 below), in which case the bottom field of a current coded field must be treated differently. For example, if in step 605 it is determined that the current coded field X is not a top field, processing moves to step 607, where it is determined whether or not the current coded field X is itself marked as a reference field (for example Br in FIG. 7). If the current coded field X is not marked as a reference field, then the selection process is carried out the same as above. In other words, processing moves to step 609 where it is determined whether or not the reference frame R is marked as a still type frame. If so, then the top field of the reference frame is fetched, step 613, for use in coding the current coded field X. If in step 609 it is determined that the reference frame is not marked as a still type frame, then the bottom field of the reference frame R is fetched for coding with the current coded field X, step 611.

However, if it is determined in step 607 that the current coded field X is marked as a reference frame, then processing moves to step 613 where the top field of the reference frame R is fetched for processing with the bottom field of the current coded field X.

This processing is reflected in FIG. 7, whereby it can be seen that if a current coded field is a bottom field and marked as a reference field, for example the bottom field 23₂ of Reference B-picture frame 23, it can be seen that this bottom field can also reference the top field of the reference frame 23, i.e. the top field 23₁ (shown by the dotted line 23ₓ). The same applies to the bottom fields 21₂ and 25₂ of frames 21 and 25, respectively. It is noted that FIG. 7 does not show all possible references for clarity purposes.

The method of FIG. 6 also deals with the situation where the reference frame is a “future” reference frame. In such a situation, if it is determined in processing step 603 that the reference frame is not marked as LO, implying that the reference frame is a future reference frame, then the top field is fetched from the reference frame R for coding purposes, step 613, regardless of whether or not the current field to be coded is a top field or a bottom field.

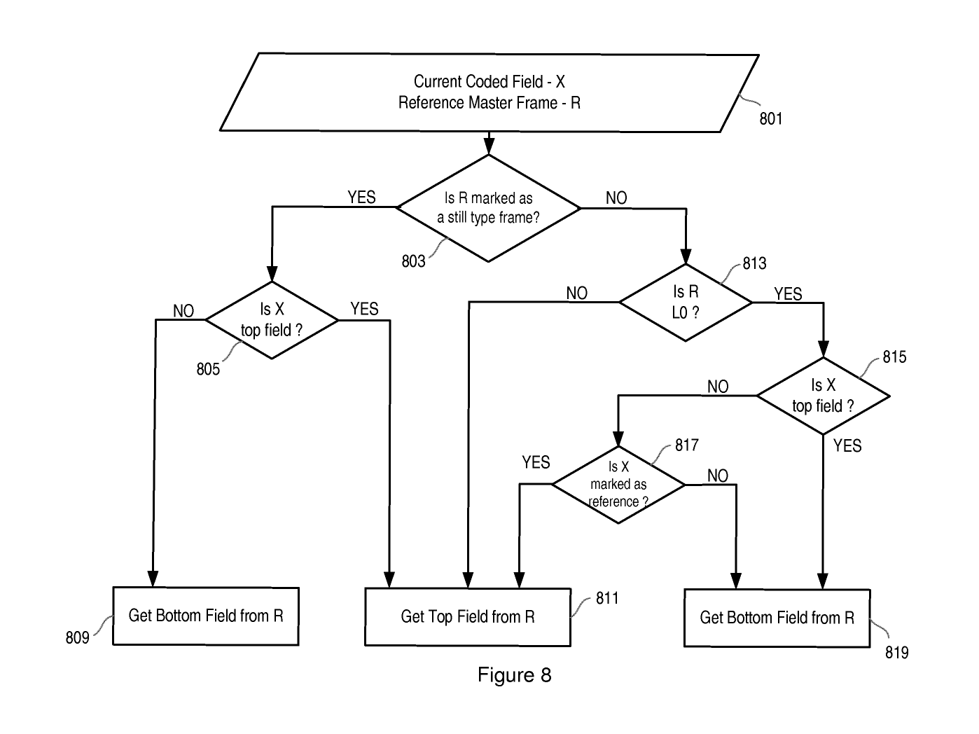

FIG. 8 describes a method according to another embodiment of the present invention.

A current coded field (or first field) is shown as X, and a reference master frame shown as R, 801. In step 803 it is determined whether the reference frame R is marked as a still type frame. If so, processing moves to step 805 where it is determined whether or not the current coded field X is a top field (i.e. whether the first field is a top field). If so, then the top field of the reference frame is fetched, step 811, for use in coding the top field of the current coded field X. If in step 805 it is determined that the current coded field X is not a top field (i.e. a bottom field), then the bottom field of the reference frame R is fetched, step 809, for coding with the bottom field of the current coded field X.

If in step 803 it is determined that the reference frame R is not marked as a still type frame (for example either explicitly or implicitly marked as a moving type frame), then processing moves to step 813. In step 813 it is determined whether the reference frame is a past reference frame or a future reference frame (for example by checking whether the reference frame R is marked as being low (LO), whereby a reference frame marked as LO indicates that the reference frame is a past reference frame).

If it is determined in step 813 that the reference frame R is LO (indicating a past reference frame), then in step 811 a top field from the reference frame is fetched, for processing with the current coded field X (regardless of whether the current coded field is a top field or a bottom field).

As such, it can be seen that, if the reference frame is not marked as a still type frame, then this part of the method comprises the steps of determining whether the reference frame is a future reference frame and, if so, selecting a top field of the reference frame (step 811) regardless of whether or not the first field of the current frame is a top field or a bottom field.

If it is determined in step 813 that the reference fame is marked LO, indicating a past reference frame, then processing moves to step 815 where it is determined whether the current coded field X (or first field) is a top field. If so, processing moves to step 819 where the top field of the reference frame R is fetched, for use in coding the top field of the current coded field X. If in step 815 it is determined that the current coded field X is not the top field, then processing moves to step 817 where it is determined whether the current coded field X (or first field) is itself marked as a reference. If so, the top field of the reference frame R is fetched, step 811. If it is determined in step 817 that the current coded field X (or first field) is not marked as a reference, then the bottom field of the reference frame R is fetched, step 819.

From the above it can be seen that, if the reference frame is marked as not being of still type (i.e. moving type), the method comprises the steps of determining in step 813 whether the reference frame is a past reference frame and, if so, determining in step 815 whether the first field X of the current frame is a top field, and:
if so, selecting a bottom field of the reference frame in step 819; and
if not, selecting a top field of the reference frame (steps 817, 811) if the first field is itself marked as a reference frame, or selecting a bottom field of the reference frame (steps 817, 819) if the first field of the current frame is not marked as a reference frame.

This processing is reflected in FIG. 7 mentioned above, whereby it can be seen how the different frames can reference one another.

It will be appreciated that reducing the number of reference fields used in a coding process can help to achieve increased density in a video encoder without a penalty for a decoder. Default H.264 ordering of reference fields does not deliver optimum video coding efficiency. With the proposed embodiments of the invention video compression efficiency can be improved at no penalty on resources usage on both an encoder side and a decoder side.

It is noted that although the embodiments of the invention describe frames being marked as still type frames or moving type frames, it is noted that one of these may be marked implicitly. For example, determining that a frame is not a still type frame can be taken as an implicitly assumption that the frame is a moving type frame, or vice versa.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method of coding a video signal, wherein each picture frame of the video signal is associated with one or more reference frames, each reference frame comprising a first field and a second field, the method comprising:
receiving a current frame to be coded;
selecting a first field or a second field of a reference frame for coding a first field of the current frame, wherein the selecting is performed based on the content of the video signal; and
coding the first field of the current frame using the selected field of the reference frame.

2. The method as claimed in claim 1, wherein the selecting step comprises the steps of:
determining whether the reference frame is marked as a still type frame or a moving type frame; and
selecting a first field or a second field of a reference frame according to whether the reference frame is marked as a still or a moving type frame.

3. The method as claimed in claim 2, further comprising the step of selecting the first field of the reference frame when the reference frame is marked as a still type frame.

4. The method as claimed in claim 2, further comprising the step of selecting the second field of the reference frame when the reference frame is marked as a moving type frame.

5. The method as claimed in claim 2 further comprising, if the reference frame is determined as being marked a moving type frame, performing the steps of:
determining whether the reference frame is a past reference frame and, if so;
determining whether the first field of the current frame is a top field, and:
if so, selecting a bottom field of the reference frame; and
if not, selecting a top field of the reference frame if the first field is itself marked as a reference frame, or selecting a bottom field of the reference frame if the first field of the current frame is not marked as a reference frame.

6. The method as claimed in claim 2 wherein, if the reference frame is determined as being marked a moving type frame, further comprising the steps of determining whether the reference frame is a future reference frame and, if so, selecting a top field of the reference frame regardless of whether or not the first field of the current frame is a top field or a bottom field.

7. The method as claimed in claim 2, wherein the method further comprises a pre-processing step of:
measuring a temporal proximity between first fields and second fields of a frame and an adjacent frame of the video signal;
determining whether the temporal proximity between the first and second fields of the frame and adjacent frame is smaller than a predetermined threshold, and:
if so, marking the frame as a still type frame; and
if not, marking the frame as a moving type frame.

8. The method as claimed in claim 7, wherein the pre-processing step comprises the steps of performing the measuring and determining steps for a group of frames, and marking the group of frames as a still type or a moving type.

9. The method as claimed in claim 8, further comprising the step of switching from using a first reference field to using a second reference field in response to a group of frames being determined as changing from a still type to a moving type, or vice versa.

10. A video encoding apparatus for coding a video signal, wherein each picture frame of the video signal is associated with one or more reference frames, each reference frame comprising a first field and a second field, the apparatus comprising:
a receiving unit for receiving a current frame to be coded;
a processing unit adapted to select a first field or a second field of a reference frame for coding a first field of the current frame, wherein the selection is performed based on the content of the video signal; and
a coding unit adapted to code the first field of the current frame using the selected field of the reference frame.

11. The apparatus as claimed in claim 10, wherein the processing unit is further adapted to:
determine whether the reference frame is marked as a still type frame or a moving type frame; and
select a first field or a second field of a reference frame according to whether the reference frame is marked as a still type frame or a moving type frame.

12. The apparatus as claimed in claim 11, wherein the processing unit is further adapted to select the first field of the reference frame when the reference frame is marked as a still type frame.

13. The apparatus as claimed in claim 11, wherein the processing unit is further adapted to select the second field of the reference frame when the reference frame is marked as a moving type frame.

14. The apparatus as claimed in claim 11, wherein if the reference frame is determined as being marked a moving type frame, the processing unit is further adapted to perform the steps of:
determining whether the reference frame is a past reference frame and, if so;
determining whether the first field of the current frame is a top field, and:
if so, selecting a bottom field of the reference frame; and
if not, selecting a top field of the reference frame if the first field is itself marked as a reference frame, or selecting a bottom field of the reference frame if the first field of the current frame is not marked as a reference frame.

15. The apparatus as claimed in claim 11 wherein, if the reference frame is determined as being marked a moving type frame, the processing unit is further adapted to determine whether the reference frame is a future reference frame and, if so, select a top field of the reference frame regardless of whether or not the first field of the current frame is a top field or a bottom field.

16. The apparatus as claimed in claim 11, wherein the processing unit is further adapted, during a pre-processing stage, to perform the operations of:
measuring a temporal proximity between the first and second fields of a frame and an adjacent frame of the video signal;
determining whether the temporal proximity between the first and second fields of the frame and adjacent frame is smaller than a predetermined threshold, and:
if so, marking the frame as a still type frame; and
if not, marking the frame as a moving type frame.

17. The apparatus as claimed in claim 16, wherein the processing unit is adapted to perform the measuring and determining operations for a group of frames, and mark the group of frames as a still type or a moving type.

18. The apparatus as claimed in claim 17, wherein the processing unit is further adapted to switch from using a first reference field to using a second reference field in response to a group of frames being determined as changing from a still type to a moving type, or vice versa.
